(19) United States
(12) Patent Application Publication
(10) Pub. No.: US 2021/0233110 A1
(43) Pub. Date: Jul. 29, 2021

(54) SYSTEMS AND METHODS FOR PROVIDING TARGETED DIGITAL ADVERTISEMENTS TO CUSTOMERS AT A RETAIL STORE

(71) Applicant: Walmart Apollo, LLC, Bentonville, AR (US)

(72) Inventors: Yanbin Ye, Bentonville, AR (US); Zhichun Xiao, Plano, TX (US)

(21) Appl. No.: 17/162,321

(22) Filed: Jan. 29, 2021

Related U.S. Application Data
(60) Provisional application No. 62/967,381, filed on Jan. 29, 2020.

(51) Int. Cl. G06Q 30/02; H04N 5/247; G06K 9/00; G06F 3/14; G06F 3/0481; G06F 3/0484

(52) U.S. Cl. CPC G06Q 30/0255; G06Q 30/0269; G06Q 30/0273; G06Q 30/0264; G06F 3/04842; H04N 5/247; G06K 9/00335; G06F 3/1423; G06F 3/0481; G06Q 30/0281

(57) ABSTRACT

Systems and methods are for providing targeted advertisements to customers at a retail store include digital display devices and digital cameras that capture physical characteristics data and behavioral data associated with the in-store customers of the retail store. The system also includes a computing device that obtains, from an electronic advertisement database, a request for the purchase of the targeted advertisements by a client wishing to digitally advertise at the store, and the physical characteristics data, behavioral data, and/or historical sales data. The computing device then correlates the request for the purchase of the targeted advertisements by the client to the physical characteristics data, behavioral data, and/or historical sales data in order to determine a schedule for displaying the targeted advertisements to in-store customers via the digital display devices, and to select one or more of the digital display devices for displaying the targeted advertisements to the in-store customers.

### CROSS-REFERENCE TO RELATED APPLICATIONS

This application claims the benefit of U.S. Provisional Application No. 62/967,381, filed Jan. 29, 2020, which is incorporated herein by reference in its entirety.

### TECHNICAL FIELD

This disclosure relates generally to providing advertisements to in-store customers, and, in particular, to systems and methods for providing targeted advertisements to in-store customers using one or more electronic displays.

### BACKGROUND

Brick-and-mortar stores of large retailers have thousands of customers walking therethrough while shopping every day. Given the suggesting power of advertising (e.g., product promotions and sales), many retailers place product advertisements near the store entrances to attract the attention of the customers to certain featured/promotional/on-sale products. For example, paper-based and electronic displays are widely used at retail stores to display general advertisements of products and services to the customers that enter the retail stores.

Generally, given the large variance in demographics of the customers that shop at retail stores, it is difficult for retailers to provide targeted digital advertising to in-store customers. Likewise, it appears to be difficult to measure the effectiveness of targeted digital advertisements (e.g., due to the difficulty of using the traditional key performance indicators (e.g., organic traffic, impression, click-rate, etc.) that are used to measure the effectiveness of internet advertising).

### BRIEF DESCRIPTION OF THE DRAWINGS

Disclosed herein are embodiments of systems and methods for providing targeted advertisements to customers at a retail store.

This description includes drawings, wherein:

FIG. 1 is a diagram of a system of providing targeted advertisements to customers at a retail store in accordance with some embodiments;

FIG. 2 is a functional block diagram of a computing device in accordance with some embodiments; and

FIG. 3 is a flow diagram of a process of providing targeted advertisements to customers at a retail store in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally, this application describes systems and methods of providing targeted advertisements to customers at a retail store include digital display devices and digital cameras that capture physical characteristics data and behavioral data associated with the in-store customers of the retail store. The system also includes a computing device that obtains, from an electronic advertisement database, at least one of the requests for the purchase of the targeted advertisements by the clients, as well the physical characteristics data, behavioral data, and/or historical sales data. The computing device then correlates requests for the purchase of the targeted advertisements by the clients to the physical characteristics data, behavioral data, and/or historical sales data in order to determine a schedule for displaying the targeted advertisements to in-store customers via the digital display devices, as well as to select one or more of the digital display devices for displaying the targeted advertisements to the in-store customers. By way of the systems and methods described herein, the audience of the retail store advertising system could be measured and predicted based on the sales data and monitored customer behavior data, the audience and targeted advertisements could be easily associated and correlated based on various modeling methods, and targeted advertising content could be pushed to the display system based on pre-defined rules or models, followed by a collection of data representing the response of the audience to the targeted advertisements.

In some embodiments, a system for providing targeted advertisements to customers at a retail store includes digital display devices located in a plurality of locations at the retail store and configured to display the advertisements to the customers located at the retail store; digital cameras configured to capture physical characteristics data and behavioral data associated with the customers of the retail store; and an electronic advertisement database in communication with the digital cameras. The electronic advertisement database is configured to store: electronic data associated with requests for purchase of targeted advertisements by clients to advertise products or services of the clients to the customers located at the retail store via the digital display devices located at the retail store; electronic data representing historical sales data collected at the retail store over a pre-defined time period; and electronic data representing the physical characteristics data and the behavioral data captured by the digital cameras in association with the customers of the retail store. The system further includes a computing device including a processor-based control circuit and being in communication over a network with the digital display devices, the digital cameras, and the advertisement database. The control circuit is configured to: obtain, from the electronic advertisement database, at least one of the requests for the purchase of the targeted advertisements by the clients; obtain, from the electronic advertisement database, at least one of the electronic data representing the physical characteristics data, the behavioral data associated with the customers of the retail store, and the historical sales data; correlate at least one of the requests for the purchase of the targeted advertisements by the clients to the at least one of the physical characteristics data, the behavioral data, and the historical sales data in order to: determine a schedule for displaying the targeted advertisements associated with the at least one of the requests by the clients to the customers of the retail store via the digital display devices; and select one or more of the digital display devices for displaying the targeted advertisements associated with the at least one of the requests by the clients to the customers at the retail store; and based on the determined schedule, transmit a control signal to the one or more of the digital display devices selected by the control unit. In response to receipt of the control signal from the computing device, the one or more of the digital display devices selected by the control unit are configured to display the targeted advertisements associated with the at least one of the requests by the clients to the customers at the retail store.

In other embodiments, a method of providing targeted advertisements to customers at a retail store includes: providing a plurality of digital display devices located in a plurality of locations at the retail store and configured to display the advertisements to the customers located at the retail store; providing a plurality of digital cameras configured to capture physical characteristics data and behavioral data associated with the customers of the retail store; providing an electronic advertisement database in communication with the digital cameras and configured to store: electronic data associated with requests for purchase of targeted advertisements by clients to advertise products or services of the clients to the customers located at the retail store via the digital display devices located at the retail store; electronic data representing historical sales data collected at the retail store over a pre-defined time period; and electronic data representing the physical characteristics data and the behavioral data captured by the digital cameras in association with the customers of the retail store; providing a computing device including a processor-based control circuit and being in communication over a network with the digital display devices, the digital cameras, and the advertisement database; obtaining, by the control circuit and from the electronic advertisement database, at least one of the requests for the purchase of the targeted advertisements by the clients; obtaining, by the control circuit and from the electronic advertisement database, at least one of the electronic data representing the physical characteristics data, the behavioral data associated with the customers of the retail store, and the historical sales data; correlating, via the control circuit, the at least one of the requests for the purchase of the targeted advertisements by the clients to the at least one of the physical characteristics data, the behavioral data, and the historical sales data; by the control circuit and based on the correlating: determining a schedule for displaying the targeted advertisements associated with the at least one of the requests by the clients to the customers of the retail store via the digital display devices; and selecting one or more of the digital display devices for displaying the targeted advertisements to the customers at the retail store; and based on the determined schedule, transmitting a control signal to the one or more of the digital display devices selected by the control unit; in response to receipt of the control signal from the computing device, displaying, by the one or more of the digital display devices selected by the control unit, the targeted advertisements associated with the at least one of the requests by the clients to the customers at the retail store.

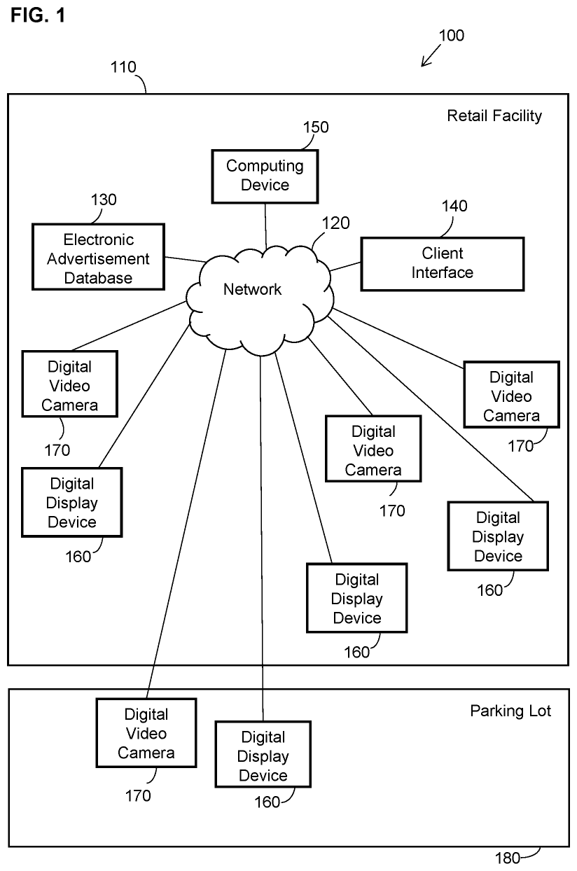

FIG. 1 shows an exemplary embodiment of a system 100 for providing targeted advertisements to customers at a retail store 110. The system includes digital display devices 160 configured to display targeted advertisements to the customers located at the retail store 110. The digital display devices 160 may be located in a variety of locations throughout the retail store 110 (only three digital display devices 160 are shown in FIG. 1 for simplicity) and/or in the parking lot 180 of the retail store 110 (only one digital display device 160 is shown in FIG. 1 for simplicity). In some embodiments, the digital display devices 160 may be located, for example, in the parking lot 180 near the entrance to the retail store 110, near fresh food/deli displays at the retail store, near the shelves and/or refrigerators/freezers in the aisles of the retail store 110, near the checkout registers of the retail store 110.

In some aspects, the digital display devices 160 are standalone digital displays (e.g., TV/computer monitors) that are mounted to/placed on a support structure. In other aspects, the digital display devices 160 are personal computing devices that have a display screen, such as tablets, smartphones, or the like. The digital display devices 160, whether standalone digital displays, or displays of computing devices, may be configured for interactivity with the customers, permitting the customers to interact with the digital advertisements, for example, to get more details on a product or to order a product, or to search for a product or an advertisement of a given product or product category, or to input their feedback with respect to the digital advertisement displayed on the digital display devices 160. For example, in some embodiments, digital display devices 160 may include input devices such as a touch screen, a keyboard, a touchpad, a motion sensor, a speaker, a motion detector, radar, etc. for detecting users and/or interacting with users.

In some embodiments, the digital display devices 160 include a customer sensor configured to detect a presence of a customer proximate thereto. In some embodiments, the digital display devices 160 may be, for example, liquid crystal displays (LCD), light emitting diode (LED) displays, organic LED (OLED) displays, projection displays, and the like. In some embodiments, the digital display devices 160 may communicate with the electronic advertisement database 130 and/or computing device 150 and/or a separate remote advertisement server over the network 120 to display digital advertisements to the customers located at the retail store 110. The digital display devices 160 may be of various sizes and shapes without departing from the spirit of the present invention. In some embodiments, a digital display device 160 may comprise a projector and a projection display instead of an electronic screen. While the digital display devices 160 and the digital video cameras 170 are shown in FIG. 1 as separate and distinct devices, it will be appreciated that, in some aspects, each of the digital display devices 160 may also include a built in digital video camera 170 configured to capture behavioral data associated with the customers of the retail store 110, both when the customers move through the retail store 110, and when the in-store customers are presented with a targeted advertisement on the screen of the digital display devices 160.

With reference to FIG. 1 the system 100 further includes digital video cameras 170 configured to capture physical characteristics data and behavioral data associated with the customers of the retail store 110. The digital video cameras 170 may be located in a variety of locations throughout the retail store 110 (only three digital video cameras 170 are shown in FIG. 1 for simplicity) and/or in the parking lot 180 of the retail store 110 (only one digital video cameras 170 is shown in FIG. 1 for simplicity). In some embodiments, the digital video cameras 170 may be located, for example, in the parking lot 180 near the entrance to the retail store 110, near fresh food/deli displays at the retail store 110, near the shelves and/or refrigerators/freezers in the aisles of the retail store 110, near the checkout registers of the checkout store 110, etc.

In certain aspects, the digital video cameras 170 are located near the digital display devices 160 in order to capture the reactions of the customers to the advertisements being displayed to the customers on the digital display devices 160. In some aspects, the digital video cameras 170 are positioned throughout the retail store 110 and/or parking lot 180 to capture physical characteristics data associated with the customers of the retail store 110, for example, gender, estimated age (e.g., child, teenage, youth adult, senior, etc.), body size, position, and facing direction of the customers, facial characteristics of the customers, clothing being worn by the customers, or the like. In various aspects, the digital video cameras 170 are positioned throughout the retail store 110 and/or parking lot 180 to capture behavioral data associated with the customers of the retail store 110, for example, facial expressions (smile, frown, puzzled look, etc.) of the customers, words spoken by the customers, speed of movement of the customers, walking path of the customers, possession of mobile devices by the customers, time spent by the customers at a given location of the retail store 110, time spent by the customers viewing each of the displayed targeted advertisements, clothing worn by the customers, or the like.

In some embodiments, each of the digital video cameras 170 is configured to include or couple to a transceiver that permits the digital video cameras 170 to transmit the captured physical characteristics data and/or behavioral data associated with the customers of the retail store 110 to an electronic advertisement database 130 and/or a computing device 150, which are described in more detail below. For example, the digital video cameras 170 may be configured to capture the physical characteristic data associated with the customers of the retail store 110 as the customers move throughout the retail store 110 and/or parking lot 180, and to transmit, to the electronic advertisement database 130 and/or computing device 150, the captured physical characteristics data exhibited by the customers in response to being presented with the targeted advertisements on the digital display devices 160. In other aspects, the digital video cameras 170 may be configured to capture the behavioral data exhibited by the customers of the retail store 110 in response to being presented with the targeted advertisements on the digital display devices 160, and to transmit, to at least one of the electronic advertisement database 130 and the computing device 150, the captured behavioral data exhibited by the customers in response to being presented with the targeted advertisements on the digital display devices 160.

The systems and methods described herein can be configured to comply with privacy requirements which may vary between jurisdictions. For example, before any recording, collection, capturing or processing of customer data, a “consent to capture” process may be implemented. In such a process, consent may be obtained, from the customer, via a registration process. Part of the registration process may be to ensure compliance with the appropriate privacy laws for the location where the service would be performed. The registration process may include certain notices and disclosures made to the customer prior to the customer giving consent. In other words, the exemplary systems and methods described herein provide for no unauthorized/unconsented to collection or processing of data of customers.

In some embodiments, after registration, and before collection or processing of customer data, the system verifies that the customer as registered with the system and has provided the required consent for data collection. That is, the customer's registration status as having consented to the collection of the customer's data can be verified by the system prior to collecting any customer data. In some embodiments, once customer consent is verified, customer data can be captured, processed and used. In some embodiments, absent verification of consent, the customer data collection features of the system may remain inactive, and once customer consent is verified, the customer data collection features of the system may be activated. In some aspects, if the system detects that customer data was inadvertently collected from the customer prior to verification of that customer's consent to the data collection, such collected data is immediately deleted, not having been saved to disk.

In some embodiments, customer data captured as part of the verification process is handled and stored by a single party at a single location. In some aspects, where data must be transmitted to an offsite location for verification, certain disclosures prior to consent are required, and the customer data is encrypted. The hashing of the customer data received is a form of asymmetrical encryption which improves both data security and privacy, as well as reducing the amount of customer data which needs to be communicated. In some embodiments, the data being shared by the user can be changed by the user at any time.

In the embodiment of FIG. 1, the system includes an electronic advertisement database 130. In some embodiments, the electronic advertisement database 130 is configured to store electronic data including, but not limited to: (1) electronic data associated with requests for purchase of targeted advertisements by clients to advertise products or services of the clients to the customers located at the retail store 110 via the digital display devices 160 located at the retail store 110; (2) electronic data representing historical sales data collected at the retail store 110 over a pre-defined time period (e.g., one or more weeks, one or more months, one or more years, etc.); (3) electronic data representing the physical characteristics data and the behavioral data captured by the digital video cameras 160 in association with the customers of the retail store 110, and the like. The electronic advertisement database 130 may be stored, for example, on non-volatile storage media (e.g., a hard drive, flash drive, or removable optical disk) internal or external to the computing device 150, or internal or external to computing devices separate and distinct from the computing device 150. It will be appreciated that the electronic advertisement database 130 may likewise be cloud-based.

In some embodiments, the electronic advertisement database 130 stores digital advertisements (which may be submitted by or for the clients that wish advertise their products/services on the digital display devices 160 in the retail store 110), and display parameters associated with each of the advertisements. In some embodiments, the electronic advertisement database 130 is further configured to maintain user data, including but not limited to user accounts, user device associations, user shopping histories, user product preferences, user advertisement preferences, permissions, etc.

In some aspects, the electronic advertisement database 130 stores electronic data representing various parameters associated with the retail store 110 (which are analyzed by the computing device 150 as described below), for example, location of the retail store 110, size of the retail store 110 (including historical and predicted foot traffic), historical/predicted demographics of customers of the retail store 110, purchase history/predicted purchases of customers at the retail store 110, product categories (e.g., cosmetics, sport events, concerts, food products, beverage products, etc.), product keywords (e.g., kids, sports, toys, back-to-school, electronics, household items, etc.), price plans for digital advertising for clients based on running dates/times of the targeted advertisements, etc. In one aspect, the client is permitted, via the client interface 140, to upload the video file containing the advertisement to be run at the retail store 110 to the electronic advertisement database 130.

The exemplary system of FIG. 1 further includes a client interface 140, which permits a client (e.g., vendor, marketer, or the like) wishing to advertise the client's goods/services on the digital display devices 160 to the customers located at the retail store 110, to submit a request for purchase of a targeted advertisement spot to advertise the products or services of the client to the electronic advertisement database 130. The client interface 140 may be displayed on an electronic device of the client, which may include but is not limited to: a stationary or portable electronic device, for example, a desktop computer, a laptop computer, a tablet, a mobile phone, or any other electronic device including a processor-based control circuit.

In some aspects, as the client is connecting via the client interface 140 over the network 120 to the computing device 150 or to the electronic advertisement database 130, the retailer computing device 150 or electronic advertisement database 130 may request a verification of the identity (e.g., username/password) of the client. For example, the computing device 150 may first verify the identity of the client (e.g., by comparing the username/password data entered by the client into the client interface 140 against username/password data in the profile of the client stored in the electronic advertisement database 130). This enables the computing device 150 to associate the profile of the client with the identity of the client, and to retrieve account information of the client stored in the retrieved profile.

In some aspects, the client interface 140 includes one or more input fields configured to permit the client to input one or more parameters of the targeted advertisement that the client wishes to run on the digital display devices 160 at the retail store 110 for the in-store customers. Exemplary parameters of targeted advertisements that may be entered by a client (e.g., vendor, marketer, etc.) using the client interface 140 and uploaded to the electronic advertisement database 130 include, but are not limited to: geographic location of the retail store 110, size of the retail store 110 (including desired foot traffic), customer demographics of interest to the client, customer purchase history, dates for displaying the targeted advertisement at the retail store 110, times for displaying the targeted advertisements at the retail store 110, product category (e.g., cosmetics, sport events, concerts, food products, beverage products, etc.), keywords (e.g., kids, sports, toys, back-to-school, electronics, household items, etc.) cost of advertisement to the client, etc.

In one aspect, the client is permitted, via the client interface 140, to upload the video file containing the advertisement to be run at the retail store 110 to the electronic advertisement database 130. As will be discussed in more detail below, the advertisement parameters submitted by the client via the client interface 140 are used by the control circuit 210 to characterize the targeted audience for the digital advertisement of the client to be displayed at the retail store 110.

In some embodiments (as discussed in more detail below), the client interface 140 is configured to include a graphical menu that permits the client to view an advertisement proposal (generated by the computing device 150) for the client. For example, an exemplary advertisement proposal generated by the computing device 150 based on the analysis of the physical characteristics data and behavioral data associated with the customers of the retail store 110 may include, for example, the specific retail store 110, where the computing device 150 proposes for the client's digital advertisements to run, as well as the specific digital display devices 160 at the retail store 110 which will run the client's digital advertisement, the schedule (i.e., days, times, and duration) of running the client's digital advertisement at the retail store 110, the potential targeting audience estimation (e.g., expected foot traffic of customers to which the digital advertisement is expected to be displayed at the retail store 110 on the digital display devices 160), and the proposed cost to the client for accepting the proposed digital advertisement deployment plan generated by the computing device 150.

In certain implementations, after the advertisement proposal is displayed to the client in the client interface 140, the client interface 140 displays a graphical element that permits the client to purchase the advertisement proposal generated on the client interface 140 for the client by the computing device 150. In one aspect, in response to an interaction with the graphical element of the client interface 140 by the client to purchase the advertisement proposal, the client interface 140 generates and transmits a signal (to the electronic advertisement database 130 and/or computing device 150) that is indicative of the order for a targeted advertisement to be run at the retail store 110 that has been placed by the client.

With reference to FIG. 1, the system further includes a computing device 150, which may be a stationary or portable electronic device, for example, a desktop computer, a laptop computer, a tablet, a mobile phone, or any other electronic device including a processor-based control circuit (i.e., control unit). For purposes of this specification, the term “computing device 150” will be understood to refer to a computing device owned by the retailer or any computing device owned and/or operated by an entity (e.g., delivery service) having an obligation to deliver products 190 for the retailer.

In the embodiment of FIG. 1, the computing device 150 is configured for data entry and processing as well as for communication with other devices of system 100 via the network 120. In some embodiments, as will be described below, the computing device 150 is configured to receive electronic data from/transmit electronic data to the electronic advertisement database 130, digital display devices 160, and/or digital video cameras 170.

In some embodiments, the computing device 150 is configured to aggregate and analyze still/moving images received by the computing device 150 from the digital video cameras 170 and/or obtained by the computing device 150 from the electronic advertisement database 130. In some aspects, the computing device 150 may further be configured to perform image processing and provide still/moving images to the digital display devices 160 for display thereon. In some embodiments, the computing device 150 may comprise a cloud server implemented on the processors of a plurality of digital display devices 160 and/or other devices.

In some embodiments, the computing device 150 may incorporate or be operatively coupled to a digital advertisement broadcast service, which facilitates, at the time selected by the computing device 150, the transmission of control signals to digital display devices 160 selected by the computing device 150, in order to cause the digital display devices 160 to render thereon one or more targeted advertisements selected by the computing device 150. While only four (three in-store and one parking lot) digital display devices 160 are shown in FIG. 1 for simplicity, in some embodiments, the computing device 150 may simultaneously support dozens or hundreds of digital display devices 160 in displaying targeted advertising content to the customers located in the retail store 110 or parking lot 180.

In the exemplary embodiment illustrated in FIG. 1, the components of the system 100 communicate with one another via a network 120. The network 120 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of system 100 may take place over hard-wired, radio frequency-based, cellular, Wi-Fi, or Bluetooth networked components, or the like. In some embodiments, one or more electronic devices of system 100 may include cloud-based features, such as cloud-based memory storage.

In some embodiments, the system 100 includes one or more localized Internet-of-Things (IoT) devices and controllers in communication with the computing device 150. As a result, in some embodiments, the localized IoT devices and controllers can perform most, if not all, of the computational load and associated monitoring that would otherwise be performed by the computing device 150, and then later asynchronous uploading of summary data can be performed by a designated one of the IoT devices to the computing device 150, or a server remote to the computing device 150. In this manner, the computational effort of the overall system 100 may be reduced significantly. For example, whenever a localized monitoring allows remote transmission, secondary utilization of controllers keeps securing data for other IoT devices and permits periodic asynchronous uploading of the summary data to the computing device 150 or a server remote to the computing device 150.

In addition, the periodic asynchronous uploading of summary data may include a key kernel index summary of the data as created under nominal conditions. In an exemplary embodiment, the kernel encodes relatively recently acquired intermittent data (“KRI”). As a result, in some embodiments, KRI includes a continuously utilized near term source of data, but KM may be discarded depending upon the degree to which such KM has any value based on local processing and evaluation of such KRI. In an exemplary embodiment, KM may not even be utilized in any form if it is determined that KM is transient and may be considered as signal noise. Furthermore, in some embodiments, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In some aspects, KRG incrementally sequences all future undefined cached kernels of data in order to filter out data that may reflect generic background data. In other aspects, KRG incrementally sequences all future undefined cached kernels having encoded asynchronous data in order to filter out data that may reflect generic background data.

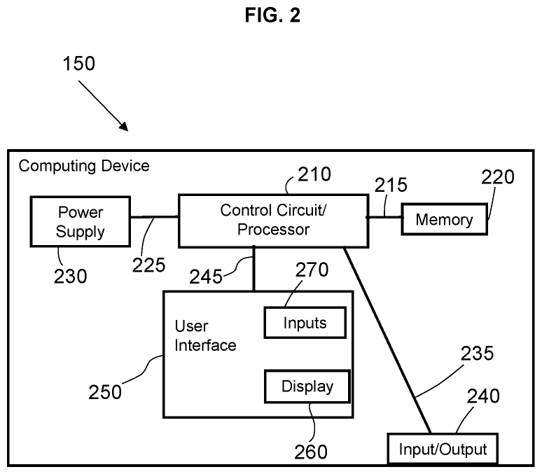

With reference to FIG. 2, an exemplary computing device 150 configured for use with exemplary systems and methods described herein may include a control circuit 210 including a processor (for example, a microprocessor or a microcontroller) electrically coupled via a connection 215 to a memory 220 and via a connection 225 to a power supply 230. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

This control circuit 210 can be configured (for example, by using corresponding programming stored in the memory 220 as will be well understood by those skilled in the art) to carry out one or more of the steps, actions, and/or functions described herein. In some embodiments, the memory 220 may be integral to the processor-based control circuit 210 or can be physically discrete (in whole or in part) from the control circuit 210 and is configured non-transitorily store the computer instructions that, when executed by the control circuit 210, cause the control circuit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

The control circuit 210 of the computing device 150 is also electrically coupled via a connection 235 to an input/output 240 that can receive signals from the electronic advertisement database 130, client interface 140, digital display devices 160, and digital video cameras 170, or from any other source configured to communicate with the computing device 150 via a wired or wireless connection (e.g., network 120). The input/output 240 of the computing device 150 can also send signals over the network 120, for example, the electronic advertisement database 130, client interface 140, digital display devices 160, and digital video cameras 170, or to any other electronic device in wired or wireless communication (e.g., over the network 120) with the computing device 150.

In the embodiment shown in FIG. 2, the processor-based control circuit 210 of the computing device 150 is electrically coupled via a connection 245 to a user interface 250, which may include a visual display or display screen 260 (e.g., liquid crystal display (LCD) screen, light-emitting diode (LED) screen, etc.) and/or button input 270 that provide the user interface 250 with the ability to permit an operator of the computing device 150 to manually control the computing device 150 by inputting commands via touch-screen and/or button operation and/or voice commands to, for example, to activate a selected digital video camera 170 at the retail store 110 for an interval of time determined by the computing device 150. It will be appreciated that the performance of such functions by the processor-based control circuit 210 of the computing device 150 is not dependent on a human operator, and that the control circuit 210 may be programmed to perform such functions without a human operator.

In some aspects, the display screen 260 of computing device 150 is configured to display various graphical interface-based menus, options, and/or alerts that may be transmitted to the computing device 150 and displayed on the display screen 260 in connection with various aspects of permitting the clients to submit requests for targeted advertisement spots, permitting the clients to bid on/purchase targeted advertisement proposals generated by the computing device 150, generating a schedule for running the targeted advertisements at the retail store 110, selecting the digital display devices 160 on which to run the targeted advertisements, etc. For example, the inputs 270 of the computing device 150 may be configured to permit an operator to navigate through the on-screen menus on the computing device 150 and select which one or more of the digital video cameras 170 to activate at the retail store 110 in order to run a targeted advertisement of products and/or services of a client. It will be appreciated that the display screen 260 may be configured as both a display screen and an input 270 (e.g., a touchscreen that permits an operator to press on the display screen 260 to enter text and/or execute commands.)

As mentioned above, in some aspects, the electronic advertisement database 130 stores electronic data including but not limited to: (1) electronic data associated with requests for purchase of targeted advertisements by clients to advertise products or services of the clients to the customers located at the retail store 110 via the digital display devices 160 located at the retail store 110; (2) electronic data representing historical sales data collected at the retail store 110 over a pre-defined time period; and (3) electronic data representing the physical characteristics data and the behavioral data captured by the digital video cameras 170 in association with the customers of the retail store 110. In some aspects, the control circuit 210 of the computing device 150 is programmed to obtain the data stored in the electronic advertisement database 130.

For example, in some embodiments, the control circuit 210 of the computing device 150 causes the computing device 150 to obtain, from the electronic advertisement database 130, at least one of the requests for the purchase of the targeted advertisements by the clients. After the client's advertisement request for digital advertising via the digital display devices 160 at the retail store 110 is obtained by the computing device 150 from the electronic advertisement database 130, the control circuit 210 is programmed to analyze the advertisement request and the electronic data available to the computing device 150 via the electronic advertisement database 130 in order to determine an optimal schedule and optimal locations at the retail for running the client's digital advertisement.

To that end, in some aspects, the control circuit 210 is programmed to cause the computing device 150 to obtain, from the electronic advertisement database 130, the electronic data representing the physical characteristics data associated with the customers of the retail store 110, the behavioral data associated with the customers of the retail store 110, and/or the historical sales data associated with the customers of the retail store 110. As mentioned above, the physical characteristics data and behavioral data are captured by the digital video cameras 170 positioned throughout the retail store 110 and in the parking lot 180 of the retail store 110. As mentioned above, in some embodiments, the digital video cameras 170 are configured to capture the behavioral data exhibited by the customers of the retail store 110 in response to being presented with the targeted advertisements on the digital display devices 160, and to transmit such captured behavioral data to the electronic advertisement database 130 and/or computing device 150).

In some embodiments, this captured behavioral data is compiled and normalized by the customer behavior data collection system function of the computing device 150, and is made accessible for the clients (e.g., vendors, marketers, etc.) on the electronic advertisement database 130 and the client interface 140 as part of the campaign report function of the present system 100, in order to permit the clients to review and track the results (i.e., effectiveness) of the digital advertisements that have been displayed to the customers at the retail store 110. In one aspect, since the sales and foot traffic data may be considered sensitive/proprietary information by the retailer that operates the retail store 110, the electronic advertisement database 130 may be configured to make the actual foot traffic and product sales numbers inaccessible to the clients, instead making the normalized and averaged (e.g., based on the region, stores, product categories and client specific) numbers available to the clients.

In some aspects, the behavioral data captured by the digital video cameras 170 while observing the reactions of the customers of the retail store 110 in response to being presented with the targeted advertisements on the digital display devices 160 may include, but is not limited to: customer foot traffic near the digital display devices 160, customer dwelling/focusing time at the digital display devices 160, customer's interactions (clicking, searching, etc.) with the screens of the digital display devices 160, head nods, head shakes, smiles, frowns, spoken words, hand gestures, customer traffic around etc.

As such, the control circuit 210 of the computing device 150 can utilize machine learning to analyze the captured behavioral data to monitor/measure the objective effectiveness of the targeted advertisements that are presented to the customers of the retail store 110. To that end, in some embodiments, the control circuit 210 of the computing device 150 is programmed to incorporate the captured feedback data, i.e., behavioral data exhibited by the customers in response to being presented with the targeted advertisements on the digital display devices 160 into a correlation of the requests for the purchase of the targeted advertisements by the clients to the physical characteristics data, the behavioral data, and the historical sales data.

In some embodiments, the control circuit 210 of the computing device 150 is programmed to correlate the requests for the purchase of the targeted advertisements by the clients to the physical characteristics data, behavioral data, and/or historical sales data associated with the customers of the retail store 110 in order to determine a schedule of specific times and time intervals for displaying the requests for the purchase of the targeted advertisements by the clients to the customers of the retail store 110 via the digital display devices 160, and in order to select one or more of the digital display devices 160 at the retail store 110 for displaying the targeted advertisements to the customers at the retail store 110.

In particular, in some embodiments, the computing device 150 is configured to obtain electronic data from the electronic advertisement database 130, and to correlate this data in order to predict the demographics, foot traffic, and shopping patterns of the customers at the retail store 110, which in turn permits the computing device 150 to determine the most effective times and the most effective locations at the retail store 110 for displaying various digital advertisements to the in-store customers via the digital display devices 160. In other words, in some aspects, the computing device 150 performs the function of an advertisement scheduling system. In certain implementations, the correlation of data performed by the control circuit 210 of the computing device 150 does not require the computing device 150 to determine the identity of the customers of the retail store 110.

In other words, the behavioral data and physical characteristic data and purchase history data associated with the customers of the retail store 110 is collected by components of the system 100 (e.g., digital video cameras 170, electronic advertisement database 130, computing device 150, etc.) for statistical analysis in order to enable the computing device 150 to generate a prediction of foot traffic, demographics, and shopping schedules of a target audience at the retail store 110 (and to subsequently generate a proposed digital advertisement deployment plan for the client), not for tracking/identifying the customers of the retail store 110.

In some aspects, after the control circuit 210 of the computing device 150 determines a schedule and the digital display devices 160 for running the client's digital advertisement of interest at the retail store 110, the control circuit 210 of the computing device is programmed to generate an advertisement proposal including the total cost of the advertisement proposal for the client. In one aspect, the control circuit 210 is programmed to cause the computing device 150 to transmit the advertisement proposal to the client interface 140, such that a client is able to access the advertisement proposal generated by the computing device 150, and view the advertisement proposal (e.g., the schedule of the targeted advertisements of the goods or services of the client, the number of and locations of the digital display devices 160 at the retail store 110 that will run the advertisement, and the total cost to the client for having the targeted advertisements run at the retail store for a given period of time).

In some embodiments, the advertisement proposal, which allows the clients) to bid on/order the digital advertising spots at the retail store 110, is displayed within the client interface 140 such that a graphical menu displays certain information relating to the digital advertisement, for example, basic information about the store sales categories, potential customer demographics, potential customer traffic distributions per predefined displaying sections, look-alike models for the buyer's targeted audience, etc. For example, for local real estate advertisement agency, the information displayed within the client interface 140 in association with the client advertisement proposal may include the specific section of the retail store 110, where the control circuit 210 of the computing device 150 predicts that the customers that are more likely to be interested in real estate-related offers will be located.

In certain implementations, if the client purchases (e.g., by clicking on a graphical element within the client interface 140) the advertisement proposal generated for the client by the computing device 150, and the computing device 150 receives a signal from the client interface 140 indicative that the client placed an order based on the advertisement proposal, the control circuit 210 is programmed to cause the computing device 150 to transmit a control signal to one or more of the digital display devices 160 selected by the control unit 210, with this control signal causing the digital display devices 160 to display the digital advertisements of the client at scheduled times and for time intervals determined by the computing device 150 (and indicated in the aforementioned advertisement proposal). In other words, in some aspects, the computing device 150 performs the function of a digital contents broadcast system. In response to receipt of this control signal from the computing device 150, the digital display devices 160 selected by the control unit 210 of the computing device 150 are configured to display (at predetermined times and for predetermined time intervals) the targeted advertisements of the client's goods/services to the customers at the retail store 110.

With reference to FIGS. 1-3, one method 300 of operation of the system 100 for providing targeted advertisements to customers of a retail store 110 will now be described. For exemplary purposes, the method 300 is described in the context of the system of FIG. 1, but it will be appreciated by those of ordinary skill in the art that embodiments of the method 300 may be implemented in the system 100 or other systems.

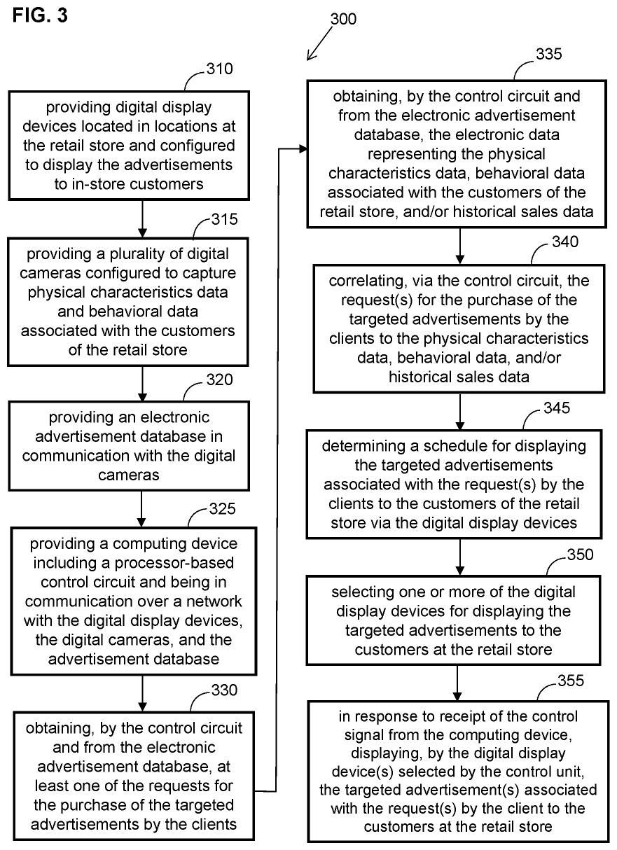

As shown in FIG. 3, the method 300 includes providing a plurality of digital display devices 160 located in a plurality of locations at the retail store 110 and configured to display the advertisements to the customers located at the retail store 110 (step 310). As mentioned above, the digital display devices may be located anywhere inside the retail store 110 and also in the parking lot 180 of the retail store 110 to maximize the exposure of the customers of the retail store 110 to the digital advertisements being displayed at the retail store 110.

The method 300 of FIG. 3 further includes providing a plurality of digital video cameras 170 configured to capture physical characteristics data and behavioral data associated with the customers of the retail store 110 (step 320). As mentioned above, in certain aspects, the digital video cameras 170 are configured to capture the physical characteristics data and the behavioral data exhibited by the customers of the retail store 110 while the customers are generally shopping at the retail store 110, and while the customers are exposed to/observing/reacting to the targeted advertisements displayed to the customers on the digital display devices 160 at the retail store 110. In some embodiments, the digital video cameras 170 are configured to transmit such captured physical characteristics data and behavioral data over the network 120 to the electronic advertisement database 130 and/or computing device 150.

In some embodiments, as mentioned above, this captured behavioral data is compiled and normalized, and is made accessible for the clients (e.g., vendors, marketers, etc.) on the electronic advertisement database 130 via the client interface 140 in order to permit the clients to review and track the results (i.e., effectiveness) of the digital advertisements that were displayed on the digital display devices 160 at the retail store 110 for the in-store customers. As mentioned above, each of the digital video cameras 170 may include or be operatively coupled to a transceiver that permits the digital video cameras 170 to transmit the captured physical characteristics data and the behavioral data associated with the customers of the retail store 110 to the electronic advertisement database 130 and/or to the computing device 150.

In the embodiment illustrated in FIG. 3, the method 300 further includes providing an electronic advertisement database 130 in communication with the digital video cameras 170 (step 320). As described above, in certain implementations, the electronic advertisement database 300 is configured to store electronic data including but not limited to: electronic data associated with requests for purchase of targeted advertisements by clients to advertise products or services of the clients to the customers located at the retail store 110 via the digital display devices 160 located at the retail store 110; electronic data representing historical sales data collected at the retail store 110 over a pre-defined time period; and/or electronic data representing the physical characteristics data and the behavioral data captured by the digital cameras 170 in association with the customers of the retail store 110.

The method 300 of FIG. 3 further includes providing a computing device 150 including a processor-based control circuit 210 and being in communication over a network 120 with the digital display devices 160, the digital video cameras 170, and the advertisement database 130 (step 325). As mentioned above, the computing device 150 is configured to obtain electronic data from the electronic advertisement database 130, and to correlate this data in order to predict the demographics, foot traffic, and shopping patterns of the customers at the retail store 110, which in turn permits the computing device 150 to determine the most effective times and the most effective locations at the retail store 110 for displaying various digital advertisements to the customers while they shop at the retail store 110.

To that end, the method 300 of FIG. 3 further includes obtaining, by the control circuit 210 and from the electronic advertisement database 130, at least one of the requests for the purchase of the targeted advertisements by the clients (step 330) and obtaining, by the control circuit 210 and from the electronic advertisement database 130, electronic data representing the physical characteristics data, behavioral data, and/or historical sales data associated with the customers of the retail store 110 (step 335). In addition, the method 300 of FIG. 3 includes correlating, via the control circuit 210, the at least one of the requests for the purchase of the targeted advertisements by the clients to the physical characteristics data, behavioral data, and historical sales data associated with the customers of the retail store 110 and obtained by the computing device 150 from the electronic advertisement database 130 (step 340).

As mentioned above, the correlation of data performed by the control circuit 210 of the computing device 150 in step 340 does not require the computing device 150 to determine the identity of the customers of the retail store 110. In various implementations, the behavioral data and physical characteristic data and purchase history data associated with the customers of the retail store 110 is collected by components of the system (e.g., digital video cameras 170, electronic advertisement database 130, computing device 150, etc.) for statistical analysis in order to generate a prediction of foot traffic, demographics, and shopping schedules of a target audience at the retail store 110 (and to generate a targeted digital advertisement deployment plan for the client), not for identifying individual customers of the retail store 110. To that end, the method 300 of FIG. 3 further includes: (1) determining, by the control circuit 210 and based on the correlating step 340, a schedule for displaying the targeted advertisements associated with the at least one of the requests by the clients to the customers of the retail store 110 via the digital display devices 160 (step 345); and selecting, by the control circuit 210 and based on the correlating step 340, one or more of the digital display devices 160 for displaying the targeted advertisements to the customers at the retail store 110 (step 350).

As mentioned above, after the control circuit 210 of the computing device 150 determines a schedule and the digital display devices 160 for running the client's digital advertisement at the retail store 110, the control circuit 210 of the computing device 150 is programmed to generate an advertisement proposal including the total cost of the advertisement proposal for the client. For example, the computing device may transmit the advertisement deployment plan proposal to the client interface 140 to enable the client to view the advertisement proposal within the client interface 140. The advertisement deployment plan proposal displayed to the customer within the client interface 140 may include, for example, the schedule of the targeted advertisements of the goods or services of the client, the number/locations of the digital display devices 160 at the retail store 110 that will run the advertisement, and the total cost to the client for having the targeted advertisements run at the retail store 110 for a given period of time).

As mentioned above, the advertisement proposal displayed to the client within the client interface 140 may include certain information relating to the digital advertisement including but not limited to basic information about the retail store 110, sales categories, potential customer demographics, potential customer traffic distributions per predefined displaying sections, look-alike models for the buyer's targeted audience, etc. In certain implementations, if the client purchases (e.g., by clicking on a graphical element within the client interface 140) the advertisement proposal generated for the client by the computing device 150, the computing device 150 receives a signal from the client interface 140 indicative that the client placed an order based on the advertisement plan proposal.

As mentioned above, in some embodiments, the client interface 140 is configured to permit the client (e.g., client desiring to advertise goods/services at the retail store 110) to submit the advertisement parameters of interest and to automatically bid on a digital advertising plan/proposal generated, based on the above-described correlation of data, by the computing device 150. For example, in one aspect, the client may provide a geographical location the client is interested in, the keywords or category relating to the digital advertisement of the client, and the advertising dates/times of interest to the client. In some aspects, in response to the parameters provided via the client interface 140 by the client, the computing device obtains the advertisement parameters submitted by the client, and correlates the advertisement parameters submitted by the client with the physical characteristics data associated with the customers, behavioral data associated with the customers, and historical sales data associated with the customers, and generates a detailed advertisement deployment proposal plan. The advertisement deployment proposal plan is then transmitted by the computing device 150 to the client.

The client, via the client interface 140, can view the advertisement deployment proposal plan, which may include, for example, the specific retail store 110, where the computing device 150 proposes for the client's digital advertisements to run, as well as the specific digital display devices 160 which will run the client's digital advertisement, the schedule (i.e., days, times, and duration) of running the client's digital advertisement, the potential targeting audience estimation (e.g., the expected foot traffic of customers to which the digital advertisement will be displayed on the digital display devices), and the proposed cost to the client for accepting the proposed digital advertisement deployment plan generated by the computing device 150. As mentioned above, when the client interface 140 displays the advertisement deployment plan to the client, the client interface may include one or more graphical elements that permit the client to accept the plan (right away or at a later time), decline the plan, or propose modifications to the plan (e.g., to reduce the total cost to the client).

In some aspects, the graphical bidding mode of the client interface 140 may include various (more advanced) graphical elements and/or input fields that provide more detailed historical information to the client in relation to the retail store 110, and provide more control to the client (in terms of both exposure of the target audience to the advertisement and total advertisement cost) by permitting the client to modify (e.g., increasing or reducing) the number of digital display devices 160 for displaying the client's digital advertisement at the retail store 110, as well as modifying (e.g., increasing or decreasing) the scheduled times and/or the scheduled time periods for displaying the client's digital advertisement at the retail store 110.

In some aspects, after the client purchases (e.g., by clicking on a graphical element within the client interface 140) the original (or client-modified) advertisement proposal generated for the client by the computing device 150, and after the computing device 150 receives a signal from the client interface 140 indicative that the client placed an order based on the advertisement proposal, the control circuit 210 transmits a control signal to one or more of the digital display devices 160 selected by the control unit 210. This control signal transmitted by the computing device 150 causes the digital display devices 160 to display the digital advertisements of the client at scheduled times and for time intervals determined by the computing device 150, thereby advertising the client's goods/services to the customers at the retail store 110 (step 355).

As mentioned above, in some embodiments, digital video cameras 170 capture the behavioral data exhibited by the customers of the retail store 110 in response to being presented with the targeted advertisements on the digital display devices 160, and transmit such captured behavioral data to the electronic advertisement database 130 and/or computing device 150. In some aspects, the behavioral data captured by the digital video cameras 170 and exhibited by the customers of the retail store 110 in response to being presented with the targeted advertisements on the digital display devices 160 may include, but is not limited to: customer foot traffic near the digital display devices 160, customer dwelling/focusing time at the digital display devices 160, customer's interactions (clicking, searching, etc.) with the screens of the digital display devices 160, head nods, head shakes, smiles, frowns, spoken words, hand gestures, customer traffic around etc. Thus, the control circuit 210 of the computing device 150 analyzes the captured behavioral data to monitor/measure the objective effectiveness of the targeted advertisements that are presented to the customers of the retail store 110, and is programmed to use subsequently use this captured behavioral data (as part of its machine learning function) to more accurately predict target audiences, foot traffic, shopping patterns, and reactions of future customers for future clients that attempt to order digital advertisements for display at the retail store 110. In some embodiments, this captured behavioral data is compiled and normalized, and is made accessible for the clients (e.g., vendors, marketers, etc.) on the electronic advertisement database 130 via the client interface 140 in order to permit the clients to review and track the results (i.e., effectiveness) of the digital advertisements that the clients purchased to run at on the digital display devices 160 for the customers located at the store 110.

The systems and methods described herein advantageously use measurable, trackable and predictable store data and customer behavior data in order to predict and target the expected marketing in-store audience and accurately measure the feedback/responses of the in-store audience. As such, the systems and methods for providing targeted advertisements to in-store customers as described herein effectively convert conventional brick and mortar retail stores into powerful digital marketing channels that provide targeted digital advertisements to customers of a retail store while the customers shop, thereby providing additional income for retailers (i.e., by way of selling advertising space), and providing an effective marketing tool for various clients.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for providing targeted advertisements to customers at a retail store, the system comprising:
a plurality of digital display devices located in a plurality of locations at the retail store and configured to display the advertisements to the customers located at the retail store;
a plurality of digital cameras configured to capture physical characteristics data and behavioral data associated with the customers of the retail store;
an electronic advertisement database in communication with the digital cameras and configured to store:
electronic data associated with requests for purchase of targeted advertisements by clients to advertise products or services of the clients to the customers located at the retail store via the digital display devices located at the retail store;
electronic data representing historical sales data collected at the retail store over a pre-defined time period; and
electronic data representing the physical characteristics data and the behavioral data captured by the digital cameras in association with the customers of the retail store;
a computing device including a processor-based control circuit and being in communication over a network with the digital display devices, the digital cameras, and the advertisement database, the control circuit being configured to:
obtain, from the electronic advertisement database, at least one of the requests for the purchase of the targeted advertisements by the clients;
obtain, from the electronic advertisement database, at least one of the electronic data representing the physical characteristics data, the behavioral data associated with the customers of the retail store, and the historical sales data;
correlate at least one of the requests for the purchase of the targeted advertisements by the clients to the at least one of the physical characteristics data, the behavioral data, and the historical sales data in order to:
determine a schedule for displaying the targeted advertisements associated with the at least one of the requests by the clients to the customers of the retail store via the digital display devices; and
select one or more of the digital display devices for displaying, to the customers at the retail store, the targeted advertisements associated with the at least one of the requests by the clients; and
based on the determined schedule, transmit a control signal to the one or more of the digital display devices selected by the control unit;
wherein, in response to receipt of the control signal from the computing device, the one or more of the digital display devices selected by the control unit are configured to display, to the customers at the retail store, the targeted advertisements associated with the at least one of the requests by the clients.

2. The system of claim 1, wherein the digital display devices are configured to receive interactive feedback by the consumers in response to the targeted advertisements displayed to the consumers on the digital display devices at the retail store.

3. The system of claim 1, wherein the physical characteristics data captured by the digital cameras includes at least one of, gender of the customers, estimated age range of the customers, body size, position, and direction of the customers, facial characteristics of the customers.

4. The system of claim 3, wherein the behavioral data captured by the digital cameras includes at least one of facial expressions of the customers, words spoken by the customers, speed of movement of the customers, walking path of the customers, possession of mobile devices by the customers, time spent by the customers at a given location of the retail store, time spent by the customers viewing each of the displayed targeted advertisements, and clothing worn by the customers.

5. The system of claim 3, wherein the digital cameras are configured to capture the behavioral data exhibited by the customers in response to being presented with the targeted advertisements on the digital display devices, and to transmit, to at least one of the electronic advertisement database and the computing device, the captured behavioral data exhibited by the customers in response to being presented with the targeted advertisements on the digital display devices at the retail store.

6. The system of claim 5, wherein the computing device is configured to incorporate the captured behavioral data exhibited by the customers in response to being presented with the targeted advertisements on the digital display devices at the retail store into a correlation of the at least one of the requests for the purchase of the targeted advertisements by the clients to the at least one of the physical characteristics data, the behavioral data, and the historical sales data.

7. The system of claim 1, further comprising a client interface configured to submit a request for purchase of a targeted advertisement of the products or services of the client to the electronic advertisement database, the client interface including at least one input field configured to permit the client to input at least one parameter of the targeted advertisement, the at least one parameter including at least one of location of the retail store, customer demographics of interest to the client, customer purchase history, dates for displaying the targeted advertisement at the retail store, and cost of advertisement to the client.

8. The system of claim 1, wherein the client interface includes a graphical interface configured to permit the client to view an advertisement proposal for the client, the advertisement proposal including at least one of the schedule of the targeted advertisements of the goods or services of the client determined by the computing device, the digital display devices at the retail store selected by the computing device to display the targeted advertisements of the goods and services of the client, and a cost of the advertisement proposal to the client.

9. The system of claim 8, wherein the client interface includes a graphical element that permits the client to purchase the advertisement proposal generated for the client via the client interface.

10. The system of claim 9, wherein, in response to an interaction with the graphical element by the client to purchase the advertisement proposal, the client interface is configured to transmit a signal indicative of an order placed by the client to at least one of the electronic advertisement database and the computing device.

11. A method of providing targeted advertisements to customers at a retail store, the method comprising:
providing a plurality of digital display devices located in a plurality of locations at the retail store and configured to display the advertisements to the customers located at the retail store;
providing a plurality of digital cameras configured to capture physical characteristics data and behavioral data associated with the customers of the retail store;
providing an electronic advertisement database in communication with the digital cameras and configured to store:
electronic data associated with requests for purchase of targeted advertisements by clients to advertise products or services of the clients to the customers located at the retail store via the digital display devices located at the retail store;
electronic data representing historical sales data collected at the retail store over a pre-defined time period; and
electronic data representing the physical characteristics data and the behavioral data captured by the digital cameras in association with the customers of the retail store;
providing a computing device including a processor-based control circuit and being in communication over a network with the digital display devices, the digital cameras, and the advertisement database;
obtaining, by the control circuit and from the electronic advertisement database, at least one of the requests for the purchase of the targeted advertisements by the clients;
obtaining, by the control circuit and from the electronic advertisement database, at least one of the electronic data representing the physical characteristics data, the behavioral data associated with the customers of the retail store, and the historical sales data;
correlating, via the control circuit, the at least one of the requests for the purchase of the targeted advertisements by the clients to the at least one of the physical characteristics data, the behavioral data, and the historical sales data;
by the control circuit and based on the correlating:
determining a schedule for displaying, to the customers of the retail store and via the digital display devices, the targeted advertisements associated with the at least one of the requests by the clients; and
selecting one or more of the digital display devices for displaying the targeted advertisements to the customers at the retail store; and
based on the determined schedule, transmitting a control signal to the one or more of the digital display devices selected by the control unit;
in response to receipt of the control signal from the computing device, displaying, to the customers at the retail store and by the one or more of the digital display devices selected by the control unit, the targeted advertisements associated with the at least one of the requests by the clients.

12. The method of claim 11, further comprising receiving, via the digital display devices, interactive feedback by the consumers in response to the targeted advertisements displayed to the consumers on the digital display devices at the retail store.

13. The method of claim 11, wherein the physical characteristics data captured by the digital cameras includes at least one of, gender of the customers, estimated age range of the customers, body size, position, and direction of the customers, facial characteristics of the customers.

14. The method of claim 13, wherein the behavioral data captured by the digital cameras includes at least one of facial expressions of the customers, words spoken by the customers, speed of movement of the customers, walking path of the customers, possession of mobile devices by the customers, time spent by the customers at a given location of the retail store, time spent by the customers viewing each of the displayed targeted advertisements, and clothing worn by the customers.

15. The method of claim 13, further comprising:
capturing, via the digital cameras, the behavioral data exhibited by the customers in response to being presented with the targeted advertisements on the digital display devices; and
transmitting, from the digital display devices and to at least one of the electronic advertisement database and the computing device, the captured behavioral data exhibited by the customers in response to being presented with the targeted advertisements on the digital display devices at the retail store.

16. The method of claim 15, further comprising incorporating, by the computing device, the captured behavioral data exhibited by the customers in response to being presented with the targeted advertisements on the digital display devices at the retail store into the correlating of the at least one of the requests for the purchase of the targeted advertisements by the clients to the at least one of the physical characteristics data, the behavioral data, and the historical sales data.

17. The method of claim 11, further comprising providing a client interface configured to submit a request for purchase of a targeted advertisement of the products or services of the client to the electronic advertisement database, the client interface including at least one input field configured to permit the client to input at least one parameter of the targeted advertisement, the at least one parameter including at least one of location of the retail store, customer demographics of interest to the client, customer purchase history, dates for displaying the targeted advertisement at the retail store, and cost of advertisement to the client.

18. The method of claim 11, wherein the client interface includes a graphical interface configured to permit the client to view an advertisement proposal for the client, the advertisement proposal including at least one of the schedule of the targeted advertisements of the goods or services of the client determined by the computing device, the digital display devices at the retail store selected by the computing device to display the targeted advertisements of the goods and services of the client, and a cost of the advertisement proposal to the client.

19. The method of claim 18, wherein the client interface includes a graphical element that permits the client to purchase the advertisement proposal generated for the client via the client interface.

20. The method of claim 19, wherein, in response to an interaction with the graphical element by the client to purchase the advertisement proposal, the client interface is configured to transmit a signal indicative of an order placed by the client to at least one of the electronic advertisement database and the computing device.
